(19) United States
(12) Patent Application Publication
(10) Pub. No.: US 2015/0080068 A1
(43) Pub. Date: Mar. 19, 2015

(54) ASSEMBLY (DOCK) FOR CELLPHONES IN CARS

(71) Applicant: Omar Bracamontes Cruz, Distrito Federal (MX)

(72) Inventor: Omar Bracamontes Cruz, Distrito Federal (MX)

(21) Appl. No.: 14/342,679

(22) PCT Filed: Sep. 24, 2013
(86) PCT No.: PCT/MX2013/000108

§ 371 Date: Mar. 4, 2014

(30) Foreign Application Priority Data
Feb. 21, 2013 (MX) MX/A/2013/000092

(51) Int. Cl. H04M 1/60

(52) U.S. Cl. CPC H04M 1/6075
USPC 455/575.9

(57) ABSTRACT

An assembly (dock) for cell phones in cars, presenting the peculiarity that replaces the stereo, installing in the space occupied by the stereo, in such a way that by means of a computer application, the cell phone serves to tune the radio and also to keep its functions. The assembly (dock) is fixed to the front panel of the automobile and improves the interaction of the cell phone with the automobile through a downloaded software application on the phone, so the driver is provided with all the functions of the cell phone and gives up the stereo or information center. The assembly (dock) may be manufactured with standard external measures and different interior dimensions and connectors types to fit various makes and models of existing cell phones.

### CROSS REFERENCE TO RELATED APPLICATION

This application is a national stage entry of PCT/MX2013/000108 filed Sep. 24, 2013, under the International Convention claiming priority over Mexican Application No. MX/a/2013000092 filed Feb. 21, 2013.

### FIELD OF THE INVENTION

The present invention refers to an assembly (dock) for cell phones in cars, presenting the peculiarity that replaces the stereo, installing in the space occupied by the stereo, in such a way that by means of a computer application, the cell phone serves to tune the radio and also to keep its functions such as calls, messages, maps, music, etc.

### BACKGROUND OF THE INVENTION

The technological advance of cell phones enables the use of diverse functions, such as to tune the radio, listen to music, or surf on a map. Cars are designed to include stereo equipment and some are no longer simple stereos, but rather information centers for the driver with functions such as phone calls and texting with wired or wireless connections to a cell phone, as well as audio, GPS navigation, and trip computer. Another point to consider is that the use of music compact discs (CD) are already decreasing, giving way to digital music that the drivers download and store on their cell phones.

If the stereo to the cell phone connection is wired, it brings the problem of not having a place to fix it in the car, thus it may fall and get damaged. On the other hand, the capacity of the cell phones with their functions of GPS, radio, etc., is sub employ since it is used as a stereo or as the automotive information center.

The assembly (dock) according to the present invention is fixed to the front panel of the automobile and has improved the interaction of the cell phone with the automobile through a downloaded software application on the phone. Therefore, the driver is provided with all the functions of the cell phone and gives up the stereo or information center; this assembly (dock) may be manufactured with standard external measures and different interior dimensions and connectors types to fit various makes and models of existing cell phones.

This solution better employs the capacities of cell phones and can supply power to continuously charge the cell phones when they are connected.

The manufacturers could reduce manufacturing costs by giving up the acquisition of stereos and information centers, replacing this investment with the development of software applications to download on cell phones. In addition, the driver will feel a more pleasant driving experience, since it is more familiar with the cell phone than with the stereos and information centers of their cars.

Accidents caused by imprudence to send or read text messages will be decreased, since the application could block these functions while the vehicle is in motion and the cell phone is connected to the assembly (dock).

To complement the description of this disclosure and in order to help get a better understanding of the characteristics of the invention, accompanied to this description, as an integral part of the same, are the drawings that are illustrative in nature and not restrictive, are represented as follows:

### BRIEF DESCRIPTION OF THE DRAWINGS

FIG. 1 shows the general location of the assembly (dock) on the front panel of the automobile, being the place where stereos are traditionally installed.

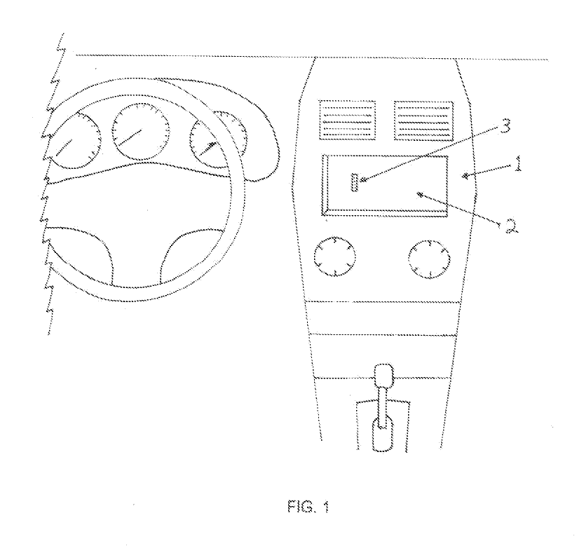

FIG. 2 shows a more detailed perspective view of the assembly (dock), with an example of a cellular phone jack.

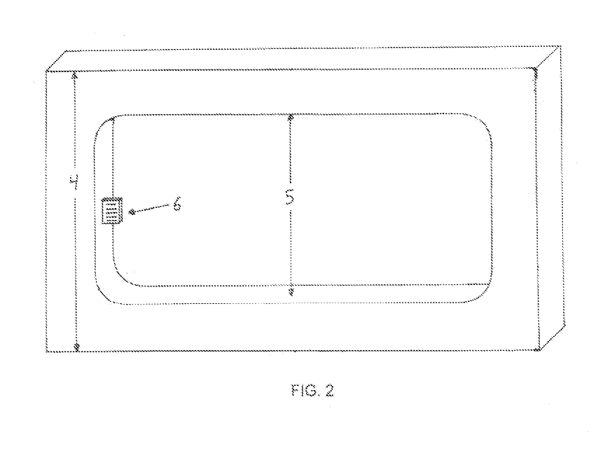

### PREFERABLE EMBODIMENT OF THE INVENTION

In view of these figures, it may be observed that the assembly (dock) is advocated as located on the front panel (1) of the automobile where traditionally stereos are installed, which leaves a cavity (2) to accommodate the assembly (dock) (4) having standard external measurements. The assembly (dock) has, at the same time an opening (5) to accommodate the cell phone. The opening (5) includes internal dimensions prefabricated depending on the cell phone owned by the driver.

A connector (6) to the phone may be located on the opening (5). The size of the connector (6) varies depending on the type of phone.

The assembly (dock) is connected on the back section to the automobile connector (3). Through an application preloaded on the cell phone, at the moment of connection to the assembly (dock), the cell phone can be used as a radio to hear music, to use maps, to use GPS, to make calls, or to send text messages.

The terms in which this application has been provided should always be taken in broad sense and not on a restrictive sense.

The materials, shape, and arrangement of the elements will be susceptible of variation as long as they do not provide an alteration of the essential features of the invention, which assert themselves then:

Having described my invention as above, I believe a novelty and claim my property in the following clause.

1. (canceled)

2. An assembly for a cell phone to be use in a car comprising:
a housing having an opening, the opening designed to fit the cellular phone;
a connector attached to the housing, the connector is designed to be operatively connected to the cell phone;
a computer application downloaded to the cell phone;
wherein the assembly is designed to fit a space occupied by a musical stereo;
wherein when the cell phone is connected to the assembly, the cell phone serves as a radio to hear music, as a GPS device, as a phone to receive calls or send text messages.

3. A combination of a car and an assembly for a cell phone comprising:
the car having a space for a music stereo;
the assembly including:
a housing having an opening, the opening designed to fit the cellular phone;
a connector attached to the housing, the connector is designed to be operatively connected to the cell phone;
a computer application downloaded to the cell phone;
wherein the assembly placed on the a space occupied by the musical stereo;
wherein when the cell phone is connected to the assembly, the cell phone serves as a radio to hear music, as a GPS device, as a phone to receive calls or send text messages.
